(19) United States
(12) Patent Application Publication
(10) Pub. No.: US 2012/0082602 A1
(43) Pub. Date: Apr. 5, 2012

(54) METHOD FOR INDUSTRIAL MANUFACTURE OF PRECIPITATED CALCIUM CARBONATE (CaCO3) FROM CARBONATE BEARING ROCKS

(75) Inventors: Ingrid Anne Munz, Oslo (NO); Arne Raaheim, Nannestad (NO); Harald Johansen, Sorumsand (NO); Jan Kihle, Skedsmokorset (NO); Oyvind Brandvoll, Oslo (NO); Are Korneliussen, Trondheim (NO)

(73) Assignee: INSTITUTT FOR ENERGITEKNIKK, Kjeller (NO)

(21) Appl. No.: 13/257,107

(22) PCT Filed: Mar. 16, 2010
(86) PCT No.: PCT/NO2010/000098

§ 371 Date: Dec. 12, 2011

(30) Foreign Application Priority Data
Mar. 17, 2009 (NO) 20091130

(51) Int. Cl. C01F 11/18

(52) U.S. Cl. 423/159

(57) ABSTRACT

Method for industrial manufacture of pure (precipitated) CaCO₃ comprising providing at least one naturally occurring carbonate bearing rock and comminuting said rock to increase its surface area. In a first reaction zone (R₁) the comminuted carbonate bearing rock is contacted with water and CO2 at a pressure higher than standard pressure, at a temperature in the range 30-500° C. and at a pH lower than 5 to thereby dissolve the carbonate. Dissolved material is conveyed from the first reaction zone (R₁) to a second reaction zone (R₂) held at a lower pressure than the first reaction zone and a pH higher than that of the first reaction zone, the presence of H⁺ ions in first and second reaction zones being caused by the reaction between CO₂ and water. In the second reaction zone the calcium carbonate is precipitated at a pH higher than 5.

Method for industrial manufacture of precipitated calcium carbonate from carbonate bearing rocks, such as e.g. limestone, marble or carbonatite.

### BACKGROUND

Precipitated calcium carbonate, PCC, is used in paper and wood processing industry as a filler or coating. Other uses are in plastics, rubber, paint or pharmaceutical industry. It is produced by a controlled synthesis to obtain the right properties with respect to morphology and particle size, and the purity requirement is severe.

PCC is manufactured by different commercial processes (Harben, 2002; Teir et al., 2005). The most usual one comprises firstly manufacture of slaked lime which is thereafter reacted with CO₂ for precipitation of calcium carbonate. Slaked lime is manufactured by calcining limestone or marble at 1000 to 1100° C. Also other processes for manufacturing PCC makes use of slaked lime which is either reacted with sodium carbonate for the manufacture of PCC or which involve an extra step of purification with ammonium chloride for manufacture of calcium chloride which is thereafter reacted with sodium carbonate.

Today's commercial processes for manufacture of PCC are very energy demanding and little environmentally friendly. Furthermore there are strong limitations to the kind of rocks/resources that are useful for manufacture of PCC and the quality of these, when a desired quality and purity of the products are to be achieved.

### OBJECTIVES

Considering prior art technology it is an object of the present invention to provide a method allowing cost effective manufacture of pure calcium carbonate from naturally occurring rocks like limestone, marble, and carbonatite.

It is a further object to provide a method as mentioned above which makes use of CO₂ both in the dissolution and the precipitation step.

It is a still further object to provide a process as mentioned above which is environmentally friendly and which does not require use of complicating chemicals like NaCO₃ or NH₄Cl.

It is a further object to provide a method as mentioned above which allows simultaneous manufacture of other valuable products based on the same rocks.

Due to the purity requirement for the end products such a combination is difficult or impossible to achieve when producing PCC based on the present commercial processes.

### THE PRESENT INVENTION

The above mentioned objects are achieved by the method defined by claim 1.

Using the method according to the present invention a highly pure calcium carbonate is achieved from natural sources of carbonate containing rocks by a cost effective and environmentally friendly process.

The method according to the present invention is a process comprising at least two steps of which the first may generally be denoted a dissolution process. Thus calcium is dissolved from naturally occurring carbonates in the first step of the process. Possible other minerals of the rock, such as e.g. silicates, oxides and graphite have an inferior reaction ability and a slower reaction kinetics than carbonates, especially calcium carbonates. These many therefore be separated out in the first step.

When it is stated that the presence of H+ ions in the first and second reaction zone (only) is due to the reaction between CO2 and water, this implies that no organic acid or mineral acid is added to reduce pH.

In a second step highly pure calcium carbonate is precipitated. The conditions of step 2 may, as in step 1, vary significantly, but it is characterizing that in step 2 a pH higher than that of step 1 is used. As discussed in the following the pH control can take place without adding further chemicals to the process.

The method according to the present invention does not require use of strong reagents and is principally based only on the reaction between appropriate relative amounts of CO₂, water, and the rock in question.

It is preferred that the method according to the invention also comprises further treatment of minerals and solid materials that are separated out in step 1. This depends on the nature of the raw materials and may comprise products like Nb or REE (rare earth elements).

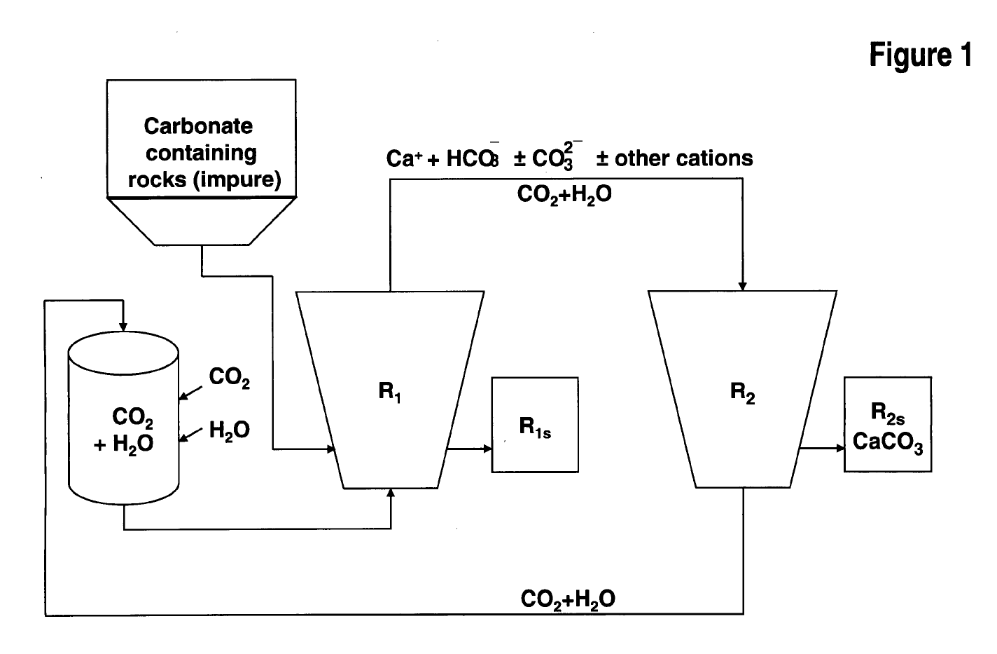

FIG. 1 is a flow scheme that schematically illustrates the general steps of the process according to the present invention.

FIG. 1 shows how CO₂ from a source that may be a combustion plant (not shown) or any other CO₂ source, is combined with water, see the mixing drum to the very left on FIG. 1. Then this combination is added to or mixed with the carbonate containing rock in a reaction zone or reaction chamber symbolized as R₁. Alternatively the rock may be mixed with water prior to being introduced in the reaction zone R₁ in which CO₂ is added directly. In this description the words (process) “step”, reaction zone” and “reaction chamber” are used as follows: A first step of the process or method takes place in a first reaction zone R₁ which typically, but not necessarily, is physically limited to a first reactor chamber. Similarly a second step of the process takes place in a second reaction zone R₂, which typically but not necessarily, takes place in a second reactor chamber. The denotations R₁ and R₂ thus generally refer to separate reaction zones but in particular embodiments also to separate reactor chambers.

Before or in R₁ the rock is comminuted (pulverized) to receive a high area to volume ratio. In water CO₂ forms carbonic acid. CO₂ however has a limited solubility in water and higher solubility at higher pressures than at low pressures. If sufficient CO₂ is added to saturate the water at all times, the pH of the solution will be a direct function of the pressure.

In the first step of the process the carbonates are dissolved in a manner that may be represented by the equation:

CaCO_{3(S)}+H⁺=Ca²⁺_{(aq)}+HCO_{3(aq)}⁻

and/or

MgCa(CO₃)₂₍ₛ₎+2H⁺=Mg²⁺_{(aq)}+Ca²⁺_{(aq)}+2HCO_{3(aq)}⁻

This reaction is sufficiently quick for industrial purposes within a wide range of pressures and temperatures, but require a pH in the acidic range and thus a certain overpressure (to dissolve a convenient amount of CO₂) in order to run optimally. If required, e.g. to remove trace amounts of iron, the redox conditions in step one (R₁) may be controlled by use of an oxidizing agent. As oxidizing agent hydrogen peroxide may typically be used.

Solid material from the first step in the form of unreacted, solid components and precipitated materials in the form of iron as mentioned above or other possible precipitated materials are separated out and conveyed to a co-ordinate zone or container R_{1S}. The liquid reaction composition is conveyed to next reaction zone R₂. From reaction zone R₁ the dissolved material is (preferably) conveyed continuously to second reaction zone R₂, from which CO₂ containing solution after precipitation of e.g. calcium carbonate is recycled as described below. In the reaction zone R₁ the solid, comminuted materials are typically being fluidized by the inflowing water and CO₂ which at least partially is charged at a vertically low level of the reaction zone while the discharge to R₂ typically takes place at a vertically high level of R₁, such as at or from the top of the reaction zone. While the pH is generally held at an acidic level in R₁, it will from natural causes by most acidic where the CO₂ is added and gradually less acidic in the direction of the discharge point from R₁ to R₂ when the process is run as a continuous process with respect to the liquid flows. It is important that the pH also near the discharge point from R₁ is maintained sufficiently low to avoid precipitation of calcium carbonate in R₁.

The solid material in R_{1S} can optionally be refined to other end products such as Nb and REE.

The liquid reaction composition which is rich in calcium ions, is conveyed to second reaction zone R₂, which has a higher pH than the first reaction zone, to thereby facilitate precipitation of calcium as calcium carbonate. The required pH adjustment may be conducted solely by reducing the pressure of the reaction composition so that the amount CO₂ dissolved in the water is reduced and thereby the content of carbonic acid in the water. It is possible, naturally, to adjust pH chemically, but the process then becomes less environmentally friendly. Precipitation of calcium carbonate is furthermore favored by high temperature. The reaction in the second step may be described as follows:

Ca²⁺+HCO3⁻=CaCO3_{(S)}+H⁺,

and

Ca²⁺+CO₃²⁻=CaCO₃₍ₛ₎

The solid calcium carbonate, CaCO_{3(S)}, is received in R_{2S} for possible further treatment or shipment.

Between first and second reaction zone it is possible but not necessary, to withdraw part of the reaction composition and recycle it to the first reaction zone. In addition it is, if not a requirement strongly preferred to recycle CO₂ from zone R₂ to reuse in zone R₁. A person skilled in the art will understand that since not only the pH is different in R₂ from R₁, but also the pressure and the temperature, the two reaction zones must be physically separated in manner allowing these differences.

Below we have briefly mentioned the most typical uses of the various product components, but it should be emphasized that the present invention is not limited to certain specific uses or products.

Solid components after first step (to R_{1S}) are mostly comprised by muscovite (biotite) and quartz if the process is conducted on regular metamorphous limestone or dolomite. If the process is conducted on carbonatite, the solid components may be magnetite, ilmenite, apatite and some materials of Nb, rare earth elements and thorium, dependent on the nature of the rock.

Precipitated calcium carbonate (to R_{2S}) (PCC) is used within paper and wood processing industry as filler or coating. Other uses are in plastic materials, rubber, paint and pharmaceutical industry. The properties and the utility value of the calcium carbonate as precipitated material is vey different from naturally occurring calcium carbonate partly due to its purity but as much due to its fine grains, its grain-shape and its consistent particle size.

As already mentioned it is according to the present invention sufficient to adjust pH by adding CO₂ to water and to adjust pressure. It is thus possible, but scarcely desirable to add mineral acids or organic acids to facilitate dissolution of the minerals in the rock. It is required to crush the rock in order to have the process run adequately at industrial conditions. It is preferred that the rock is comminuted to a particle size where the largest dimension of each particle is less than 5 mm, more preferred less than 1.0 mm and in some embodiments less than 0.1 mm. in a conventional grinding process one may by grinding, sieving, recycling, and repeated grinding ensure that all particles are within a defined boundaries of particle size if that is desired. It should, however, be emphasized that with the method according to the present invention there are no absolute demands with respect particle size. The invention will work fine if e.g. 80% of the volume of particles is within a defined limit.

In the first process step the pH needs to be in the acidic area, i.e. lower than 7. It is preferred that pH in reaction step R₁ is in the range 3.5. In same step or zone a pressure typically between 5 and 200 bars should be used, more preferred 20-200 bars and most preferred 70-200 bars. In the same step the temperature preferably is held in the range 30-220° C., more preferred 30-100° C. By allowing use of such low temperatures very large energy savings are obtained compared by today's method for the production of precipitated calcium carbonate in which temperatures about 1000° C. are used together with chemicals like NH₄Cl and NaCO₃.

In the second process step the pH is always higher than in the first process step and preferred in the range 5-13. The pressure in second reaction zone is typically in the range 1-150 bars, more preferred in the range 1-130 bars and most preferred in the range 1-80 bars. In the same step or zone the temperature is preferably in the range 5-300° C., more preferred in the range 5-250° C.

There are various ways to separate the different process steps from one another, but in a continuous process it is a requirement to use separate reactors or separate reactor chambers for the different steps so that substantially constant conditions may be applied in each of the reactors or each of the reactor chambers. The first step thus takes place in a first reactor chamber R₁ while precipitation of calcium carbonate takes place in a different reactor chamber R₂ that solely receives liquid material from the first reactor chamber while unreacted material and precipitated bi-products in first reactor chamber are first separated out.

As already mentioned the pressure is reduced from first reactor chamber to second reactor chamber so that some of the CO₂ leaves the solution and the pH is correspondingly increased. In addition the temperature is preferably increased from first to second reactor chamber to thereby favor precipitation of CaCO₃.

The carbonate bearing rock used is preferably impure limestone, impure dolomite, marble, dolomite-marble or carbonatite.

The process is typically conducted as a continuous process with respect to the liquid flow in the process and more preferred the entire process is run as a continuous process.

### OTHER ASPECTS OF THE PRESENT INVENTION

The present invention teaches a method for manufacturing precipitated calcium carbonate and/or dolomite without use of strong chemicals and without using high temperatures.

If the origin rock comprises magnesium or dolomite, magnesium ions in solution will be brought into reaction zone R₂ and be precipitated there together with calcium. For a number of applications this will not represent a “contamination” of the product or any problem in any other sense, since precipitated dolomite in combination with precipitated calcium carbonate will be as useful as pure calcium carbonate.

By high temperature as used herein is primarily referred to the temperatures used in conventional processes for the manufacture of precipitated calcium carbonate, i.e. temperatures close to 1000° C. Also temperatures in the range 500-800° C. may however be regarded as high temperatures compared to the temperatures of the present invention which preferably are well below 500° C.

Only chemical mandatory added is CO₂ which is typically delivered from a combustion plant or other CO₂ source, e.g. e power plant powered by fossil fuels or smelting plant with high CO₂ emission. The process has a mainly neutral CO₂ mass balance by CO₂ being recycled in the process and by precipitation of carbonates. The method has a competitive advantage over today's commercial processes based on calcination which involves high energy consumption and possibly considerable CO₂ emissions.

The method allows sustainable and more environmentally friendly utilization of natural resources due to the fact that (1) ordinary (impure) carbonate bearing rocks can be used for production of highly pure, precipitated calcium carbonate or dolomite without any step of (up)grading of the raw material prior to its use in the method according to the present invention, (2) bi-minerals and accessory minerals can be used in the same process, and (3) mainly climate neutral handling of CO₂.

Method for manufacturing precipitated calcium carbonate that may be utilized commercially e.g. within paper and wood processing industry as filler or coating. Other possible uses are in plastic materials, rubber, paint or pharmaceutical industry.

Method for production of bi-minerals and accessory minerals being present in impure carbonate bearing rocks and carbonatites.

Method for the manufacture of precipitated calcium carbonate that may possess new properties compared to existing commercial products.

### REFERENCES

Harben P W (2002) The industrial minerals handy book. 4th edition. Industrial minerals information
Teir S, Eloneva S and Zevenhoven R (2005) Production of precipitated calcium carbonate from calcium silicates and carbon dioxide. Energy Conversion and Management 46: 2954-2979

1. Method for the manufacture of pure, precipitated CaCO₃, comprising providing at least one naturally occurring carbonate bearing rock and to comminute the carbonate bearing rock to increase its surface, characterized in that i) in a first process step in a first reaction zone (Ri) to contact the comminuted carbonate bearing rock with water and CO₂ at a pressure higher than standard pressure, a temperature in the range between 30 and 500° C. and a pH lower than 5 to thereby dissolve the carbonate, ii) to convey the dissolved material from the first process step to a second reaction zone (R₂) held at a pressure lower than the pressure in the first reaction zone (Ri) and a pH higher than the pH of the first reaction zone, the presence of H⁺ ions in first (Ri) and second (R₂) reaction zones having their origin from the reaction between CO₂ and water, iii) in a second process step in the second reaction zone (R₂) to precipitate calcium carbonate at a pH higher than 5.

2. Method as claimed in claim 1, characterized in that material in solution in first reaction zone (Ri) is continuously conveyed to the second reaction zone (R₂) while undissolved material in first reaction zone is maintained for a certain period of time and thereafter conveyed batch wise to a laterally arranged zone (R₁ₛ).

3. Method as claimed in claim 1, characterized in that water and CO₂ in first reaction zone (R₁) fluidizes the solid, comminuted material.

4. Method as claimed in claim 1, characterized in that the carbonate bearing rock is comminuted to a particle size substantially less than 5 mm, more preferred less than 1.0 mm and most preferred less than 0.1 mm.

5. Method as claimed in claim 1, characterized in that pH in said first reaction zone (Ri) is in the range 3-5 while pH in the said second zone for precipitation is in the range 5-13.

6. Method as claimed in claim 1, characterized in that first step is performed in a first reactor chamber (Ri) and precipitation of calcium carbonate is performed in a second reactor chamber (R₂) that solely receives liquid material from first reactor chamber while unreacted reactant and precipitated bi-products from first reactor chamber are being separated out.

7. Method as claimed in claim 6, characterized in that the pressure is reduced from first reactor chamber (Ri) to second reactor chamber (R₂) so that some CO₂ thereby leaves the solution and that the pH thereby is correspondingly increased.

8. Method as claimed in claim 6, characterized in that a higher temperature is applied for reactor chamber (R₂) than for reactor chamber (R₁) to thereby facilitate precipitation of CaCO₃.

9. Method as claimed in claim 1, characterized in that the pressure in first reaction zone (R₁) is within the range 5-200 bars, more preferred 20-200 bars and most preferred 70-200 bars.

10. Method as claimed in claim 1, characterized in that the temperature in the first reaction zone (R₁) is in the range 30-220° C., more preferred in the range 30-100° C.

11. Method as claimed in claim 1, characterized in that the pressure in second reaction zone (R₂) is in the range 1-150 bars, more preferred 1-130 bars and most preferred 1-80 bars.

12. Method as claimed in claim 1, characterized in that the temperature in second reaction zone (R₂) is in the range 5-300° C., more preferred in the range 5-250° C.

13. Method as claimed in claim 1, characterized in that the carbonate bearing rock is impure limestone, impure dolomite, marble, dolomite-marble or carbonatite.

14. Method as claimed in claim 1, characterized in that the process is conducted as a continuous process with respect to the liquid flows of the process.

15. Method as claimed in claim 1, characterized in that the process is conducted as an entirely continuous process.

16. Method as claimed in claim 1, characterized in that the dissolution reaction takes place in absence of strong mineral acids and strong organic acids.

17. Method as claimed in claim 1, characterized in that the comminuted rock has a particle size less than 0.1 mm, that the pressure in the first reaction zone is in the range 70-200 bars, that the pressure in the second reaction zone is in the range 1-80 bars, that pH in the first reaction zone is in the range 3-5, that pH in the second reaction zone is in the range 5-13, that the temperature in the first reaction zone is in the range 30-100° C., that the temperature in the second reaction zone is in the range 5-250° C., that the process is run free from acids other than CO₂ dissolved in water and that the process is run as a continuous process.

18. Method as claimed in claim 1, characterized in that CaCO₃ is used in products such as paper, plastic products, rubber, paint or pharmaceutical products.

19. Method as claimed in claim 1, characterized in that silicates, oxides and other occurring solid materials are removed from the dissolution reaction for further treatment in a production plant for the manufacture of possible bi-products.
